(19) United States
(12) Patent Application Publication
(10) Pub. No.: US 2008/0251958 A1
(43) Pub. Date: Oct. 16, 2008

(54) LIGHT ABSORBING PREPOLYMERS FOR USE IN TINTED CONTACT LENSES AND METHODS FOR THEIR PRODUCTION

(76) Inventors: Frank F. Molock, Orange Park, FL (US); Christopher Fenoli, Athens, GA (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 11/868,771

(22) Filed: Oct. 8, 2007

Related U.S. Application Data
(60) Provisional application No. 60/863,750, filed on Oct. 31, 2006.

(51) Int. Cl. G02B 3/00; C08F 120/54

(52) U.S. Cl. 264/1.32; 526/303.1

(57) ABSTRACT

The present invention relates to compositions comprising a light absorbing prepolymer having a molecular weight of between about 7,000 and about 100,000 and polymeric units derived from and least one reactive light absorbing component and monomers selected from the group consisting of hydrophilic monomers, hydrophobic monomers and mixtures thereof. The compositions of the present invention are useful for the manufacture of ophthalmic devices, including contact lenses.

### FIELD OF THE INVENTION

The invention relates to colorants useful in the production of tinted contact lenses. In particular, the invention provides a one step process for tinting contact lenses and colorants for use in the process.

### BACKGROUND OF THE INVENTION

The use of tinted contact lenses to alter the natural color of the iris is well known. Generally, the tinted portion of the lens is located in the center of the lens, the portion of the lens that will overlay either or both the pupil and iris of the lens wearer. It is also well known in the tinting of contact lenses that the entire lens may be lightly tinted as a visibility or locator tint.

Colorants used to produce tinted lenses generally are composed of a binding polymer and pigments. The known colorants require the use of crosslinking agents to form covalent bonds between the lens materials and the binding polymer in order to form stable, tinted lenses. By “stable, tinted lenses” is meant that the tints do not bleed or leach out from the lens or from one portion of the lens to another. Additionally, in some of the known methods for forming tinted lenses, it is required that the lens body be formed prior to the introduction of the colorant onto the lens. Other processes and colorants require multiple steps for use alone or in conjunction with specialized rings to protect the outer portions of the lens from the colorant.

Thus, the known colorants and processes for producing tinted lenses introduce one or both of additional time and additional materials into the normal lens manufacturing process. Therefore, a need exists for a colorant, and method for producing contact lenses using the colorant, that eliminate some or all of these disadvantages.

### DETAILED DESCRIPTION OF THE INVENTION AND PREFERRED EMBODIMENTS

The invention provides colorants for use in the manufacture of tinted contact lenses, and a method for the tinting of contact lenses using the colorants of the invention. When the colorants of the invention transfer from a mold surface to the lens material in a way that results in a finished lens with a high resolution image of the pattern printed using the colorant.

In one embodiment, the invention provides a colorant for use in tinting contact lenses, the colorant comprising, consisting essentially of, and consisting of: one or more light absorbing prepolymer. In another embodiment, the invention provides a method for manufacturing a tinted contact lens comprising, consisting essentially of, and consisting of the steps of: a.) applying to a molding surface of a mold a tinting-effective amount of at least one colorant composition comprising at least one light absorbing prepolymer; b.) dispensing a lens-forming amount of a lens material into the mold; c.) swelling the colorant composition in the lens material and diffusion of the lens material into the colorant composition; and d.) curing the lens material in the mold under conditions suitable to form the tinted contact lens. In yet another embodiment, the invention provides a mold for use in manufacturing a tinted contact lens comprising, consisting essentially of, and consisting of a first and second mold half, wherein at least one molding surface of the first and second mold halves comprises, consists essentially of, and consists of: a colorant composition comprising one or more light absorbing prepolymer, wherein the light absorbing prepolymer is capable of forming an interpenetrating polymer network with a lens material.

For purposes of the invention, “interpenetrating polymer network” or “IPN” is defined as the combination of two or more independent polymers in which one polymer is synthesized and/or cross-linked in the presence of the other. Thus, some degree of interpenetration occurs within the network structures. Typically, the independent polymers used to form the IPN are in network form. One type of IPN, specifically a semi-IPN, is composed of one or more polymers that are cross-linked and one or more polymers that are not substantially cross-linked as disclosed by “Interpenetrating Polymer Networks: An Overview” by Sperling, L. H. in Interpenetrating Polymer Networks, Edited by Klempner, Sperling, and Utracki, pp 3-6 (1994). For purposes of the invention, the type of interpenetrating polymer network used is a semi-IPN. In one embodiment, the semi-IPN is formed using a lens material, which is crosslinked and a colorant composition comprising at least one light absorbing prepolymer which is not substantially crosslinked. For the purposes of this invention not substantially crosslinked means that the non-crosslinked material is not subjected to conventional crosslinking conditions prior to contact with the lens material. Semi-IPNs may be formed in one step, or in a series of steps, which are known as sequential semi-IPNs. One of ordinarily skilled in the art will recognize that, the presence of cross-linking agents, either through addition or as impurities, can create a reaction environment that favors the formation of a sequential interpenetrating polymer network.

For purposes of the invention, by “molding surface” is meant a mold surface used to form a surface of a lens.

The light absorbing prepolymers of the present invention may be formed from any monomers suitable for making ophthalmic devices, and in one embodiment, contact lenses. For example, the light absorbing prepolymers may be formed from monomers comprising hydrophilic monomers, hydrophobic monomers and mixtures thereof. One class of suitable hydrophilic monomers include acrylic- or vinyl-containing monomers. The term “vinyl-type” or “vinyl-containing” monomers refer to monomers containing the vinyl grouping (—CH═CH₂) and are generally highly reactive. Such hydrophilic vinyl-containing monomers are known to polymerize relatively easily.

“Acrylic-type” or “acrylic-containing” monomers are those monomers containing the acrylic group: (CH₂═CRCOX) wherein R is H or CH₃, and X is O or N, which are also known to polymerize readily, such as N,N-dimethyl acrylamide (DMA), 2-hydroxyethyl methacrylate (HEMA), glycerol methacrylate, 2-hydroxyethyl methacrylamide, polyethyleneglycol monomethacrylate, methacrylic acid and acrylic acid.

Hydrophilic vinyl-containing monomers which may be incorporated into the light absorbing prepolymers of the present invention include monomers such as N-vinyl amides, N-vinyl lactams (e.g. NVP), N-vinyl-N-methyl acetamide, N-vinyl-N-ethyl acetamide, N-vinyl-N-ethyl formamide, N-vinyl formamide, with NVP being preferred.

Other hydrophilic monomers that can be employed in the invention include polyoxyethylene polyols having one or more of the terminal hydroxyl groups replaced with a functional group containing a polymerizable double bond. Examples include polyethylene glycol, ethoxylated alkyl glucoside, and ethoxylated bisphenol A reacted with one or more molar equivalents of an end-capping group such as isocyanatoethyl methacrylate (“IEM”), methacrylic anhydride, methacryloyl chloride, vinylbenzoyl chloride, or the like, to produce a polyethylene polyol having one or more terminal polymerizable olefinic groups bonded to the polyethylene polyol through linking moieties such as carbamate or ester groups.

Still further examples are the hydrophilic vinyl carbonate or vinyl carbamate monomers disclosed in U.S. Pat. No. 5,070,215, and the hydrophilic oxazolone monomers disclosed in U.S. Pat. No. 4,910,277. Other suitable hydrophilic monomers will be apparent to one skilled in the art.

In one embodiment the hydrophilic comprises at least one hydrophilic monomer such as DMA, HEMA, glycerol methacrylate, 2-hydroxyethyl methacrylamide, NVP, N-vinyl-N-methyl acrylamide, polyethyleneglycol monomethacrylate, methacrylic acid and acrylic acid with DMA being the most preferred.

The hydrophilic monomers may be present in the light absorbing prepolymer in a wide range of amounts, depending upon the specific balance of properties desired. Amounts of hydrophilic monomer between about 10 and about 100 weight %, and in some embodiments between about 1 and about 50 weight percent, and in other embodiments between about 1 and about 30 weight % based upon all components used to make the light absorbing prepolymer are acceptable.

Where the ophthalmic device is a silicone hydrogel contact lens, it may be desirable to include at least one hydrophobic component, and in some embodiments at least one silicone-containing component as a monomer in making the light absorbing prepolymer. One class of hydrophobic monomers which may be included are “silicone-containing components” that contain at least one [—Si—O—]. Preferably, the total Si and attached O are present in the silicone-containing component in an amount greater than about 20 weight percent, and more preferably greater than 30 weight percent of the total molecular weight of the silicone-containing component. Useful silicone-containing components are monofunctional and preferably comprise one polymerizable functional groups such as acrylate, methacrylate, acrylamide, methacrylamide, vinyl, N-vinyl lactam, N-vinylamide, and styryl functional groups. Suitable silicone containing components include compounds of Formula I

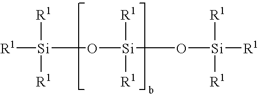

where

R¹ is independently selected from monovalent reactive groups, monovalent alkyl groups, or monovalent aryl groups, any of the foregoing which may further comprise functionality selected from hydroxy, amino, oxa, carboxy, alkyl carboxy, alkoxy, amido, carbamate, carbonate, halogen or combinations thereof, and monovalent siloxane chains comprising 1-100 Si—O repeat units which may further comprise functionality selected from alkyl, hydroxy, amino, oxa, carboxy, alkyl carboxy, alkoxy, amido, carbamate, halogen or combinations thereof,

where b=0 to 500, where it is understood that when b is other than 0, b is a distribution having a mode equal to a stated value;

wherein one R¹ comprises a monovalent reactive group.

As used herein “monovalent reactive groups” are groups that can undergo free radical and/or cationic polymerization. Non-limiting examples of free radical reactive groups include (meth)acrylates, styryls, vinyls, vinyl ethers, C₁₋₆alkyl(meth)acrylates, (meth)acrylamides, C₁₋₆alkyl(meth)acrylamides, N-vinyllactams, N-vinylamides, C₂₋₁₂alkenyls, C₂₋₁₂alkenylphenyls, C₂₋₁₂alkenylnaphthyls, C₂₋₆alkenylphenylC₁₋₆alkyls, O-vinylcarbamates and O-vinylcarbonates. Non-limiting examples of cationic reactive groups include vinyl ethers or epoxide groups and mixtures thereof. In one embodiment the free radical reactive groups comprises (meth)acrylate, acryloxy, (meth)acrylamide, and mixtures thereof.

Suitable monovalent alkyl and aryl groups include unsubstituted monovalent C₁ to C₁₆alkyl groups, C₆-C₁₄ aryl groups, such as substituted and unsubstituted methyl, ethyl, propyl, butyl, 2-hydroxypropyl, propoxypropyl, polyethyleneoxypropyl, combinations thereof and the like.

In one embodiment b is zero, one R¹ is a monovalent reactive group, and at least 3 R¹ are selected from monovalent alkyl groups having one to 16 carbon atoms, and in another embodiment from monovalent alkyl groups having one to 6 carbon atoms. Non-limiting examples of silicone components of this embodiment include 2-methyl-,2-hydroxy-3-[3-[1,3,3,3-tetramethyl-1-[(trimethylsilyl)oxy]disiloxanyl]propoxy]propyl ester (“SiMMA”), 2-hydroxy-3-methacryloxypropyloxypropyl-tris(trimethylsiloxy)silane, 3-methacryloxypropyltris(trimethylsiloxy)silane (“TRIS”), 3-methacryloxypropylbis(trimethylsiloxy)methylsilane, 3-methacryloxypropylpentamethyl disiloxane and combinations thereof.

In another embodiment, b is 2 to 20, 3 to 15 or in some embodiments 3 to 10; at least one terminal R¹ comprises a monovalent reactive group and the remaining R¹ are selected from monovalent alkyl groups having 1 to 16 carbon atoms, and in another embodiment from monovalent alkyl groups having 1 to 6 carbon atoms. In yet another embodiment, b is 3 to 15, one terminal R¹ comprises a monovalent reactive group, the other terminal R¹ comprises a monovalent alkyl group having 1 to 6 carbon atoms and the remaining R¹ comprise monovalent alkyl group having 1 to 3 carbon atoms. Non-limiting examples of silicone components of this embodiment include polydialkylsiloxanes, such as (mono-(2-hydroxy-3-methacryloxypropyl)-propyl ether terminated polydimethylsiloxane (400-1000 MW)) (“OH-mPDMS”), monomethacryloxypropyl terminated mono-n-butyl terminated polydimethylsiloxanes (800-1000 MW), (“mPDMS”).

In another embodiment b is 5 to 400 or from 10 to 300, both terminal R¹ comprise monovalent reactive groups and the remaining R¹ are independently selected from monovalent alkyl groups having 1 to 18 carbon atoms which may have ether linkages between carbon atoms and may further comprise halogen.

In another embodiment, one to four R¹ comprises a vinyl carbonate or carbamate of the formula:

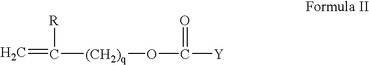

wherein: Y denotes O—, S— or NH—;

R denotes, hydrogen or methyl; d is 1, 2, 3 or 4; and q is 0 or 1.

The silicone-containing vinyl carbonate or vinyl carbamate monomers specifically include: 1,3-bis[4-(vinyloxycarbonyloxy)but-1-yl]tetramethyl-disiloxane; 3-(vinyloxycarbonylthio)propyl-[tris(trimethylsiloxy)silane]; 3-[tris(trimethylsiloxy)silyl]propyl allyl carbamate; 3-[tris(trimethylsiloxy)silyl]propyl vinyl carbamate; trimethylsilylethyl vinyl carbonate; trimethylsilylmethyl vinyl carbonate.

In one embodiment, the components used to form the prepolymer are selected from the components used to make the ophthalmic device. In another embodiment, the ophthalmic device is formed from a silicone hydrogel and the light absorbing prepolymer comprises at least one silicone-containing component selected from 2-methyl-,2-hydroxy-3-[3-[1,3,3,3-tetramethyl-1-[(trimethylsilyl)oxy]disiloxanyl]propoxy]propyl ester (“SiMMA”), 2-hydroxy-3-methacryloxypropyloxypropyl-tris(trimethylsiloxy)silane, 3-methacryloxypropyltris(trimethylsiloxy)silane (“TRIS”), 3-methacryloxypropylbis(trimethylsiloxy)methylsilane, 3-methacryloxypropylpentamethyl disiloxane, (mono-(2-hydroxy-3-methacryloxypropyl)-propyl ether terminated polydimethylsiloxane (400-1000 MW)) (“OH-mPDMS”), monomethacryloxypropyl terminated mono-n-butyl terminated polydimethylsiloxanes (800-1000 MW), mixtures thereof and the like. In another embodiment, the light absorbing prepolymer comprises repeating units derived from 3-methacryloxypropylpentamethyl disiloxane, (mono-(2-hydroxy-3-methacryloxypropyl)-propyl ether terminated polydimethylsiloxane (400-1000 MW)) (“OH-mPDMS”), monomethacryloxypropyl terminated mono-n-butyl terminated polydimethylsiloxanes (800-1000 MW), mixtures thereof and the like.

The light absorbing prepolymers also comprise at least one reactive light absorbing component which is covalent bound thereto. For the purposes of the invention, light absorbing components are those that absorb light at any wavelength including visible, UV, IR, near IR light or a combination thereof. In one embodiment, the light absorbing component absorbs light in a wavelength range comprising visible light, UV light and combinations thereof. The reactive light absorbing components may be added to the reactive mixture used to form the light absorbing prepolymer, or may be grafted onto the prepolymer backbone. In one embodiment, the light absorbing component is grafted onto the prepolymer backbone. Many light absorbing compounds are bulky, and have relatively slow reaction rates. In these embodiments grafting allows for the production of a prepolymer backbone having desirable molecular weight distributions with a range of reaction conditions. Thus, suitable reactive light absorbing components comprise a reactive group.

Any light absorbing component which can be modified to include a reactive group without substantially degrading the strength or hue of the light absorbing component may be used. Suitable light absorbing components compounds include vinyl sulfone dyes, phthalocyanine dyes, halotriazine dyes, chloroacetyl dyes, α-bromocryloyl dyes, combinations thereof and the like. In one embodiment the light absorbing components comprise at least one vinyl sulfone, chlorotriazines, and mixtures thereof. Any reactive group which is capable of reacting with the monomers in the reactive mixture or with any reactable functional group on the prepolymer may be used. Suitable reactive groups may be readily selected by those of skill in the art, depending upon the monomers used to make the binding polymer. For example, for embodiments where the reactive light absorbing component is incorporated into the reactive mixture to make the prepolymer free radical reactive groups may be included. In embodiments where the reactive light absorbing component is to be grafted to the bound to the prepolymer, suitable reactive groups on the reactive light absorbing component may selected to react with available groups on the prepolymer. For example, if 2-hydroxyethyl methacrylate is used as a monomer to make the prepolymer, the reactive groups on the reactive light absorbing component will be selected from reactive groups which form covalent bonds with a hydroxyl group, such an ester or acid. Other suitable groups for grafting include groups which can undergo condensation type reaction, aromatic nucleophilic substitution, Michael type additions, classic SN2 reactions and the like. In one embodiment the light absorbing prepolymer comprises at least one vinyl sulphone, which is grafted onto the prepolymer backbone via Michael type addition.

Specific examples of suitable reactive light absorbing components include C. I. Reactive Black 5, C.I. Reactive Black 14, C.I. Reactive Blue, 19, C.I. Reactive Blue 20, C.I. Reactive Blue 21, C.I. Reactive Blue 27, C.I. Reactive Blue 28, C.I. Reactive Blue 37, C.I. Reactive Blue 38, C.I. Reactive Orange 7, C.I. Reactive Orange 14, C.I. Reactive Orange 15, C.I. Reactive Orange 16, C.I. Reactive Orange 23, C.I. Reactive Orange 24, C.I. Reactive Orange 78, C.I. Reactive Yellow 13, C.I. Reactive 14. C.I. Reactive Yellow 15, C.I. Reactive Yellow 17, C.I. Reactive Yellow 23, C.I. Reactive Yellow 24, C.I. Reactive Yellow 37, C.I. Reactive Yellow 42, C.I. Reactive Red 21, C.I. Reactive Red 22, C.I. Reactive Red 23, C.I. Reactive Red 34, C.I. Reactive Red 35, C.I. Reactive Red 36, C.I. Reactive Red 49, C.I. Reactive Red 50, C.I. Reactive Red 63, C.I. Reactive Red 64, C.I. Reactive Red 180, C.I. Reactive Violet, C.I. Reactive Violet 5 C. I. Reactive Brown 16, and those disclosed in U.S. Pat. No. 7,060,829, U.S. Pat. No. 6,689,828, U.S. Pat. No. 5,944,853, the disclosures of which are incorporated herein by reference, combinations thereof and the like.

In another embodiment, the reactive light absorbing component comprises at least one reactive photochromic compound, such as those disclosed in PCT/US2006/013005.

The reactive light absorbing component is included in the light absorbing prepolymer in an amount effective to provide the color and color intensity desired (“coloring effective amount”). The amount of reactive light absorbing component will vary with the strength of the reactive light absorbing component, with stronger, more intense light absorbing components being used in lesser concentrations that weaker light absorbing component. For a reactive light absorbing component such as vinyl sulfone, amounts of reactive light absorbing component between about 0.2 and about 25 weight percent in the light absorbing polymer are sufficient. In one embodiment, the light absorbing prepolymer may be loaded with about 1 to about 10 weight percent light absorbing component based on the weight of light absorbing prepolymer. Combinations of reactive light absorbing component may be used in ratios dependent upon the color, shade, and hue desired.

It is a discovery of the invention that by using a light absorbing prepolymer that is capable of forming an interpenetrating polymer network with a lens material, the need for formation of covalent bonds between the light absorbing component and lens material to form a stable, tinted lens is eliminated. Stability of the tinted lens is provided by entanglements of the light absorbing prepolymer and the lens base polymer.

The light absorbing prepolymers of the invention are made from a homopolymer or copolymer, or combinations thereof, having similar solubility parameters to the lens material. These light absorbing prepolymers may contain functional groups that render the prepolymers capable of interactions with itself and the lens material. The interactions between the functional groups may be polar, dispersive, or of a charge transfer complex nature. The functional groups may be located on the polymer or copolymer backbones or be pendant from the backbones.

For example, a monomer, or mixture of monomers, that form a polymer with a positive charge may be used in conjunction with a monomer or monomers that form a polymer with a negative charge to form the light absorbing prepolymer. As a more specific example, methacrylic acid (“MAA”) and 2-hydroxyethylmethacrylate (“HEMA”) may be used to provide a MAA/HEMA copolymer that is then mixed with a HEMA/3-(N,N-dimethyl)propyl acrylamide copolymer to form the binding polymer.

The molecular weight of the light absorbing prepolymer must be such that it is somewhat soluble in the lens material and swells in it. The lens material diffuses into the light absorbing prepolymer and is polymerized and/or cross-linked. However, at the same time, the molecular weight of the light absorbing prepolymer cannot be so high as to impact the quality of the printed image. Preferably, the molecular weight of the light absorbing prepolymer is about 7,000 to about 100,000, more preferably about 7,000 to about 65,000, most preferably about 15,000 to about 55,000 Mₚₑₐₖ which corresponds to the molecular weight of the highest peak in the SEC analyses (=(Mₙ×M_{w})^{1/2})

For purposes of the invention, the molecular weight is determined using a gel permeation chromatograph with a 90° light scattering and refractive index detectors. Two columns of PW4000 and PW2500, a methanol-water eluent of 75/25 wt/wt adjusted to 50 mM sodium chloride and using polystyrene as a standard.

One ordinarily skilled in the art will recognize that, by using chain transfer agents in the production of the light absorbing prepolymer, by using large amounts of initiator, by using living polymerization, by selection of appropriate monomer and initiator concentrations, by selection of amounts and types of solvent, or combinations thereof, the desired light absorbing prepolymer molecular weight may be obtained. Preferably, a chain transfer agent is used in conjunction with an initiator, or more preferably with an initiator and one or more solvents to achieve the desired molecular weight. Alternatively, small amounts of very high molecular light absorbing prepolymer may be used in conjunction with large amounts of solvent to maintain a desired viscosity for the light absorbing prepolymer.

Chain transfer agents useful in forming the light absorbing prepolymer used in the invention have chain transfer constants values of greater than about 0.01, preferably greater than about 7, and more preferably greater than about 25,000. Suitable such chain transfer agents are known and include, without limitation, aliphatic thiols of the formula R—SH wherein R is a C₁ to C₁₂ aliphatic, a benzyl, a cyclicalipahtic or CH₃(CH₂)ₓ—SH wherein x is 1 to 24, benzene, n-butyl chloride, t-butyl chloride, n-butyl bromide, 2-mercapto ethanol, 1-dodecyl mercaptan, 2-chlorobutane, acetone, acetic acid, chloroform, butyl amine, triethylamine, di-n-butyl sulfide and disulfide, carbon tetrachloride and bromide, and the like, and combinations thereof. Generally, about 0 to about 7 weight percent based on the total weight of polymer formulation will be used. Preferably dodecanethiol, decanethiol, octanethiol, or combinations thereof is used as the chain transfer agent.

Any desirable initiators may be used including, without limitation, ultra-violet, visible light, thermal initiators and the like and combinations thereof. Preferably, a thermal initiator is used, more preferably 2,2-azobis isobutyronitrile and 2,2-azobis 2-methylbutyronitrile. The amount of initiator used will be about 0.1 to about 5 weight percent based on the total weight of the formulation. Preferably, 2,2-azobis 2-methylbutyronitrile is used with dodecanethiol.

The light absorbing prepolymers of the invention may be made by any convenient polymerization process including, without limitation, radical chain polymerization, step polymerization, emulsion polymerization, ionic chain polymerization, ring opening, group transfer polymerization, atom transfer polymerization, and the like. Preferably, a thermal-initiated, free-radical polymerization is used. Conditions for carrying out the polymerization are within the knowledge of one ordinarily skilled in the art.

Solvents useful in the production of the light absorbing prepolymer are medium boiling solvents having boiling points between about 120 and 230° C. Selection of the solvent to be used will be based on the type of light absorbing prepolymer to be produced and its molecular weight. Suitable solvents include, without limitation, diacetone alcohol, cyclohexanone, isopropyl lactate, 3-methoxy 1-butanol, 1-ethoxy-2-propanol, N,N-dimethylformamide, methylpyrrolidone and the like.

The light absorbing prepolymer of the invention is tailored, in terms of expansion factor in water, to the lens material with which it will be used. Matching or substantially matching the expansion factor of the light absorbing prepolymer with that of the cured lens material in packing solution avoids the development of stresses within the lens that result in bad optics and lens parameter shifts. Additionally, the light absorbing prepolymer must be swellable in the lens material, permitting swelling of the image printed using the colorant of the invention. Due to this swelling, the image becomes entrapped within the lens material without any impact on lens comfort.

In addition to the light absorbing prepolymer, the colorant composition of the invention contains one or more solvents that aid in coating of the colorant composition onto a surface. It is another discovery of the invention that, to ensure a colorant composition that does not bleed or run on the surface to which it is applied, it is desirable, and preferred, that the colorant composition have a surface tension below about 27 mN/m. This surface tension may be achieved by treatment of the surface, for example a mold surface, to which the colorant will be applied. Surface treatments may be effected by methods known in the art, such as, but not limited to plasma and corona treatments. Alternatively, and preferably, the desired surface tension may be achieved by the choice of solvents used in the colorant composition.

Thus, the solvents useful in the colorant composition of the invention are those solvents that are capable of increasing or decreasing the viscosity of the colorant and aiding in controlling the surface tension. Suitable solvents include, without limitation, cyclopentanones, 4-methyl-2-pentanone, 1-methoxy-2-propanol, 1-ethoxy-2-propanol, isopropyl lactate, N,N-dimethylformamide, methylpyrrolidone and the like and combinations thereof. Preferably, 1-ethoxy-2-propanol, isopropyl lactate N,N-dimethylformamide, methylpyrrolidone and combinations are used.

In another embodiment, at least three different solvents are used in the colorant composition of the invention. The first two of these solvents, both medium boiling point solvents, are used in the production of the binding polymer. Although these solvents may be stripped from the binding polymer after its formation, it is preferred that they are retained. Preferably, the medium boiling solvents are selected from 1-ethoxy-2-propanol, isopropyl lactate, N,N-dimethylformamide, methyl pyrrolidone and mixtures thereof. An additional low boiling solvent, meaning a solvent the boiling point of which is between about 75 and about 120° C., is used to decrease the viscosity of the colorant as desired. Suitable low boiling solvents include, without limitation, 2-propanol, 1-methoxy-2-propanol, 1-propanol, and the like and combinations thereof. Preferably, 1-propanol is used.

The specific amount of solvents used will depend on a number of factors. For example, the amount of solvents used in forming the binding polymer will depend upon the molecular weight of the binding polymer desired and the constituents, such as the monomers and copolymers, used in the binding polymer. The amount of low boiling solvent used will depend upon the viscosity and surface tension desired for the colorant composition. Further, if the light absorbing prepolymer is to be applied to a mold and cured with a lens material, the amount of solvent used will depend upon the lens and mold materials used and whether the mold material has undergone any surface treatment to increase its wettability. Determination of the precise amount of solvent to be used is within the skill of one ordinarily skilled in the art. Generally, the total weight of the solvents used will be about 40 to about 75 weight percent of solvent will be used.

In addition to the solvents, at least one plasticizer may be and, preferably is, added to the colorant composition to reduce cracking during the drying of the colorant composition and optical mold parts, to enhance the final quality of the image produced using the colorant composition, and to enhance the diffusion and swelling of the colorant composition by the lens material. The type and amount of plasticizer used will depend on the molecular weight of the light absorbing prepolymer used and, for colorant compositions placed onto molds that are stored prior to use, the shelf-life stability desired. Useful plasticizers include, without limitation, silicon oils, silicone containing surfactants, glycerol, propylene glycol, dipropylene glycol, tripropylene glycol, polyethylene glycol 200, 400, or 600, and the like and combinations thereof. In one embodiment the plasticizer comprises propylene glycol is used. Amounts of plasticizer used generally will be 0 to about 10 weight percent based on the weight of the binding polymer.

The opacity of the colorant composition may be controlled by varying the concentration of the light absorbing prepolymer in the colorant composition and the concentration of light absorbing prepolymer used, which can in one embodiment be readily controlled by applying multiple layers of the colorant composition(s) to the lens or lens mold. Alternatively, an opacifying agent may be used. Suitable opacifying agents, such as for example titanium dioxide or zinc oxide, are commercially available.

The absorption of colorant composition may also be controlled by mixing light absorbing prepolymer with binding polymer (prepolymer which does not contain light absorbing compounds) and solvent. For example, in some embodiments binding polymer may be included in the colorant composition in amounts of about 0 to about 40 weight % and in other embodiments between about 5- and about 15 weight %, based upon all components in the colorant composition.

In a preferred colorant mixture of the invention, about 0.30 to about 45 weight percent of light absorbing prepolymer, about 0 to about 40 weight percent binding polymer, about 40 to about 70 weight percent of solvents, about 0 to about 25 weight percent of titanium dioxide, and about 0.2 to about 7 weight percent of plasticizer is used. The weight percentages are based on the total weight of the colorant mixture.

One ordinarily skilled in the art will recognize that additives other than those discussed also may be included in the colorant composition of the invention. Suitable additives include, without limitation, additives that aid flow and leveling, additives for foam prevention, additives for rheology modification, and the like, and combinations thereof.

The light absorbing prepolymer of the invention becomes embedded in the lens material upon curing of the material. Thus, the lens absorbing prepolymer may embed closer to the front or back surface of the lens formed depending on the surface of the mold to which the lens the colorant is applied. Additionally, one or more layers of colorant composition may be applied in any order. In yet another embodiment, a clear binding polymer layer may be used in conjunction with the colorant composition. For example, in the method of the invention a clear binding polymer layer may be applied to the molding surface of a mold half prior to application of the colorant composition. The clear binding polymer may be formed from the same or different hydrophilic and hydrophobic monomers used to make the light absorbing prepolymer. If the clear binding polymer is different from the light absorbing prepolymer, it must be compatible with the light absorbing prepolymer and lens material in terms of expansion factor and swellability and it must be capable of swelling into the lens material.

The invention may be used to provide tinted hard or soft contact lenses made of any known lens material, or material suitable for manufacturing such lenses. Preferably, the lenses of the invention are soft contact lenses having water contents of about 0 to about 90 percent. More preferably, the lenses are made of monomers containing hydroxy groups, carboxyl groups, or both or be made from silicone-containing polymers, such as siloxanes, hydrogels, silicone hydrogels, and combinations thereof. Material useful for forming the lenses of the invention may be made by reacting blends of macromers, monomers, and combinations thereof along with additives such as polymerization initiators. Suitable materials include, without limitation, silicone hydrogels made from the silicone-containing components and hydrophilic components listed above, from silicone macromers and hydrophilic monomers and combinations thereof. Examples of formulations comprising silicone containing monomers, include without limitation those found in WO03/022321. Examples of silicone macromers include, without limitation, polydimethylsiloxane methacrylated with pendant hydrophilic groups as described in U.S. Pat. Nos. 4,259,467; 4,260,725 and 4,261,875; polydimethylsiloxane macromers with polymerizable function described in U.S. Pat. Nos. 4,136,250; 4,153,641; 4,189,546; 4,182,822; 4,343,927; 4,254,248; 4,355,147; 4,276,402; 4,327,203; 4,341,889; 4,486,577; 4,605,712; 4,543,398; 4,661,575; 4,703,097; 4,837,289; 4,954,586; 4,954,587; 5,346,946; 5,358,995; 5,387,632; 5,451,617; 5,486,579; 5,962,548; 5,981,615; 5,981,675; and 6,039,913; and combinations thereof. They may also be made using polysiloxane macromers incorporating hydrophilic monomers such as those described in U.S. Pat. Nos. 5,010,141; 5,057,578; 5,314,960; 5,371,147 and 5,336,797, 6,867,245; or macromers comprising polydimethylsiloxane blocks and polyether blocks such as those described in U.S. Pat. Nos. 4,871,785 and 5,034,461. All of the cited patents are hereby incorporated in their entireties by reference.

Suitable materials also may be made from combinations of oxyperm and ionoperm components such as is described in U.S. Pat. Nos. 5,760,100; 5,776,999; 5,789,461; 5,807,944; 5,965,631 and 5,958,440. Hydrophilic monomers may be incorporated into such copolymers, including 2-hydroxyethyl methacrylate (“HEMA”), 2-hydroxyethyl acrylate, N,N-dimethylacrylamide (“DMA”), N-vinylpyrrolidone, 2-vinyl-4,4′-dimethyl-2-oxazolin-5-one, methacrylic acid, and 2-hydroxyethyl methacrylamide. Additional siloxane monomers may be incorporated such as tris(trimethylsiloxy)silylpropyl methacrylate, or the siloxane monomers described in U.S. Pat. Nos. 5,998,498; 3,808,178; 4,139,513; 5,070,215; 5,710,302; 5,714,557 and 5,908,906. They may also include various toughening agents, UV blockers, and wetting agents. They can be made using diluents such as primary alcohols, or the secondary or tertiary alcohols described in U.S. Pat. No. 6,020,445. All of the cited patents are hereby incorporated in their entireties by reference.

The materials for making the contact lenses are well known and commercially available. In yet another embodiment, the lens material used is a HEMA based hydrogel, such as etafilcon A, or a polyvinyl alcohol based hydrogel. In one embodiment when the lens material is HEMA based, the light absorbing prepolymer comprises repeating units formed from methacrylic acid (“MAA”), 2-hydroxyethyl methacrylate (“HMA”) and lauryl methacrylate (“LMA”); linear random block copolymers of MAA and HEMA; linear random block copolymers of HEMA and LMA; or a HEMA homopolymer.

In yet another embodiment the lens material used is a silicone hydrogel such as galyfilcon, senofilcon, comfilcon, lotrafilcon A, lotrafilcon B or balafilcon.

The colorant composition used in the lenses of the invention are applied to the lens surface by any convenient method. In a preferred method of the invention, a thermoplastic optical mold, made from any suitable material including, without limitation, polypropylene or polystyrene resin is used. A tinting-effective amount of the colorant composition is applied to the desired portion of the molding surface of the mold. Application may be carried out by any convenient means. Preferably, application is carried out by pad or tampo printing. The colorant composition may also be applied by other methods such as those known in the art, including but not limited to ink jet printing.

A lens-forming amount of a lens material is dispensed into the mold. By “lens-forming amount” is meant an amount sufficient to produce a lens of the size and thickness desired. Typically, about 10 to about 40 mg of lens material is used.

The colorant composition is swelled in the lens material. Preferably, the swelling is carried out under conditions suitable to swell the colorant composition to about 1 to about 4 times its dried thickness. Typically, such swelling may be achieved in from about 1 to about 30 minutes at about 40 to about 68° C.

The mold containing the lens material and colorant composition then is exposed to conditions suitable to form the tinted lens. The precise conditions will depend upon the components of the colorant composition and lens material selected and are within the skill of one of ordinary skill in the art to determine. Once curing is completed, the lens is released from the mold and may be equilibrated in a buffered saline solution.

A preferred method of manufacturing a tinted lens is carried out using pad printing as follows. A metal plate, preferably made from steel and more preferably from stainless steel, is covered with a photo resist material that is capable of becoming water insoluble once cured. The pattern for applying the colorant composition is selected or designed and then reduced to the desired size using any of a number of techniques such as photographic techniques, placed over the metal plate, and the photo resist material is cured. Conditions for carrying out the pattern etching are within the knowledge of one ordinarily skilled in the art.

Following the pattern, the plate is subsequently washed with an aqueous solution and the resulting image is etched into the plate to a suitable depth, for example about 20 microns. The colorant composition is then deposited onto the pattern to fill the depressions with colorant composition. A silicon pad of a suitable geometry and varying hardness, generally about 1 to about 10 Shore A durometer units, is pressed against the image on the plate to remove the colorant composition and the colorant composition is then dried slightly by evaporation of the solvent. The pad is then pressed against the molding surface of an optical mold and the colorant composition is allowed to dry. The mold is degassed for up to 12 hours to remove excess solvents and oxygen after which the mold is filled with lens forming amount of a lens material. A complementary mold half is then used to complete the mold assembly and, after the printed image is allowed to swell, the mold assembly is exposed to conditions suitable to cure the lens material used.

The invention will be clarified further by consideration of the following, non-limiting examples.

### EXAMPLES

### Example 1

To a 100 mL flask was added 2.4 g (2.42 mmoles) Reactive Black #5 and 15 mL of DI water. The contents were stirred for 30 minutes at ambient temperature. To the flask was added 5 g, (38.42 mmoles) polyHEMA_{MW=20,000}. The reaction was stirred for 20 minutes. To the solution was then added 138.21 mg (1.00 mmole) K₂CO₃ in 5 mL of DI water. The reaction was heated to 40° C. and stirred for 96 hours. After 96 hrs, the reaction was cooled and washed with copious amounts of DI water to remove any unreacted dye. The black polymer was dried under reduced pressure to give a quantitative yield of a hard black polymer.

### Example 2

A solution of polyHEMA_{MW=12,000} in acetonitrile was dried under vacuo to remove the solvents from the polyHEMA polymer. Once all solvent was removed, the dry polymer was washed with water to remove any solvent impurities and dried under vacuo to yield a white, crystalline polymer. Five grams (38.42 mmoles) of the dried polyHEMA_{MW=12,000} was added to a solution of Reactive Black #5 [2.40 g, 2.42 mmoles] and 25 mL of DI water. The reaction was stirred for 20 minutes. To the solution was then added K₂CO₃ [165.85 mg, 1.20 mmole] in 5 mL of DI water. The reaction was heated to 40° C. and stirred for 96 hours. After 96 hrs, the reaction was cooled and the pH was adjusted to 6.5 with dilute HCL. The polymer was washed with copious amounts of DI water to remove any unreacted dye and cooled in the refrigerator overnight. The black polymer was dried under reduced pressure to yield 3.40 g of the black polymer.

### Example 3

A solution of polyHEMA_{MW=12,000} in acetonitrile was dried under vacuo to remove the solvents from the polyHEMA polymer. Once all solvent was removed, the dry polymer was washed with water to remove any solvent impurities and dried under vacuo to yield a white, crystalline polymer. Five grams of polyHEMA_{MW=12,000} (38.42 mmoles) was added to a solution of Remazol Brilliant Blue [1.52 g, 2.42 mmoles] and 25 mL of DI water. The reaction was stirred for 30 minutes. To the solution was then added K₂CO₃ [165.85 mg, 1.20 mmole] in 5 mL of DI water. The reaction was heated to 40° C. and stirred for 96 hours. After 96 hrs, the reaction was cooled and the pH was adjusted to 7.0 with dilute HCl. The polymer was washed with copious amounts of DI water to remove any unreacted dye and cooled in the refrigerator overnight. The blue polymer was dried under reduced pressure to yield 3.20 g of the blue polymer.

What is claimed is:

1. A composition comprising a light absorbing prepolymer having a molecular weight of between about 7,000 and about 100,000 and comprising polymeric units derived from and least one reactive light absorbing component and monomers selected from the group consisting of hydrophilic monomers, hydrophobic monomers and mixtures thereof, provided that said composition is substantially free of initiator.

2. The composition of claim 1 wherein said light absorbing prepolymer has a molecular weight of between about 7,000 and about 65,000.

3. The composition of claim 1 wherein said light absorbing prepolymer has a molecular weight of between about 15,000 and about 55,000.

4. The composition of claim 1 wherein said monomers comprise at least one hydrophilic monomer selected from the group consisting of N-vinyl-N-methyl acetamide, N-vinyl-N-ethyl acetamide, N-vinyl-N-ethyl formamide, N-vinyl formamide and mixtures thereof.

5. The composition of claim 1, wherein the light absorbing prepolymer is substantially non-reactive.

6. The composition of claim 1, wherein the reactive light absorbing component is polymerized in the light absorbing prepolymer's backbone.

7. The composition of claim 1, wherein the reactive light absorbing component is grafted onto the light absorbing prepolymer's backbone.

8. A colorant composition comprising at least one solvent and at least one light absorbing prepolymer having a molecular weight of less than about 65,000 and comprising polymeric units derived from and least one reactive light absorbing component and monomers selected from the group consisting of hydrophilic monomers, hydrophobic monomers and mixtures thereof.

9. The colorant composition of claim 8, wherein the at least one solvent comprises at least one medium boiling point solvent and one low boiling point solvent.

10. The colorant composition of claim 8, wherein said colorant composition comprises a surface tension of below about below about 27 mN/m.

11. The colorant composition of claim 8 wherein the medium boiling point solvents comprise 1-ethoxy-2-propanol and isopropyl lactate.

12. The colorant composition of claim 8, further comprising a plasticizer and an opacifying agent.

13. The colorant composition of claim 8 wherein the light absorbing prepolymer is substantially non-reactive.

14. A method for manufacturing a tinted contact lens comprising the steps of: a.) applying to a molding surface of a mold a tinting-effective amount of a colorant composition comprising at least one light absorbing prepolymer and one or more solvents; b.) dispensing a lens-forming amount of a lens material into the mold; c.) swelling the colorant composition in the lens material; and d.) curing the lens material in the mold to form the tinted contact lens.

15. The method of claim 14, wherein the light absorbing prepolymer has a molecular weight of less than about 65,000.

16. The method of claim 14 wherein the light absorbing prepolymer and the lens material form an interpenetrating polymer network.

17. The method of claim 14 wherein said monomers comprise at least one hydrophilic monomer selected from the group consisting of N-vinyl-N-methyl acetamide, N-vinyl-N-ethyl acetamide, N-vinyl-N-ethyl formamide, N-vinyl formamide and mixtures thereof.

18. The method of claim 14, wherein the light absorbing prepolymer is substantially non-reactive.

19. The method of claim 14, wherein the at least one solvent comprises at least one medium boiling point solvent and one low boiling point solvent.

20. The method of claim 14, wherein said colorant composition comprises a surface tension of below about below about 27 mN/m.

21. The method of claim 19 wherein the medium boiling point solvents comprise 1-ethoxy-2-propanol and isopropyl lactate
